(19) United States
(12) Patent Application Publication
(10) Pub. No.: US 2023/0413814 A1
(43) Pub. Date: Dec. 28, 2023

(54) A METHOD FOR REMOVING A BIOFILM

(71) Applicant: TECHNOLOGICAL UNIVERSITY DUBLIN, Dublin (IE)

(72) Inventors: Gordon COOKE, Dublin (IE); Emma CARAHER, Dublin (IE); Jonathan BRADY, Dublin (IE)

(73) Assignee: TECHNOLOGICAL UNIVERSITY DUBLIN, Dublin (IE)

(21) Appl. No.: 18/039,036

(22) PCT Filed: Nov. 30, 2021
(86) PCT No.: PCT/EP2021/083523

§ 371 Date: May 26, 2023

(30) Foreign Application Priority Data
Nov. 30, 2020 (GB) 2018840.5

(51) Int. Cl. A01N 37/06; A01P 1/00

(52) U.S. Cl. CPC A01N 37/06; A01P 1/00

(57) ABSTRACT

Provided is a method for preventing biofilm formation on a non-living surface. The biofilm comprising Klebsiella pneumoniae and/or Enterococcus faecalis. Provided is a method for removing, or reducing, a biofilm comprising Klebsiella pneumoniae and/or Enterococcus faecalis from a non-living surface. Preferably, the surface is the surface of a surgical instrument, a medical device, a surface in a clinical setting, or a surface in a bioprocessing facility.

### FIELD OF THE INVENTION

The current invention relates to a method for removing or disrupting a bacterial biofilm. In particular, the current invention relates to methods for removing or disrupting a bacterial biofilm from a surface. The surface may include a medical device or an environmental surface, particularly in a clinical setting.

### BACKGROUND OF THE INVENTION

Bacteria can attach to surfaces and form biofilms. A biofilm is a community of microorganisms embedded in an extracellular polymeric substance (EPS) matrix. The adherent cells tend to have a reduced growth rate and altered regulation of specific genes, compared with their freely suspended counterparts. Biofilms have a defined architecture, but every microbial biofilm is unique. The process of biofilm formation involves several key stages. The first stage involves the initial attachment of bacteria to a medical device or surface of a cell within a host. The attachment of planktonic bacteria to a surface is facilitated by the use of various adhesin molecules and cell surface appendages including pilli and fimbriae. Then microbial cells are dividing rapidly while simultaneously producing an array of exopolymeric substances (EPS) which consists of extracellular proteins, various polysaccharides and extracellular DNA (eDNA). Mature biofilm formation refers to a fully developed biofilm which has successfully colonised a medical device or host tissue. At this stage, the biofilm is at its most complex as microenvironments within the biofilm form which contributes to the emergence of persister cell.

Biofilms can form on abiotic and biotic surfaces and are prevalent in both natural and hospital settings, where they are capable of surviving for extended periods of time. The ability of bacteria to form biofilms allows for recalcitrance against conventional antibiotic therapies, natural host defenses and physical stress. This has contributed to the prevalence of biofilm acquired infections (BAI) clinically, which has resulted in increased morbidity and mortality amongst patients, with immunocompromised patients being most at risk.

Various types of surfaces in a clinical setting are prone to biofilm formation and microbial infections have been observed on most, if not all, medical devices, including implants, contact lenses, urinary catheters, prosthetic heart values, pacemakers, vascular prostheses. This presents an increased risk of disease.

Biofilms are involved in numerous diseases, device and non-device associated, and often present as chronic or recurring infections. Klebsiella pneumoniae is a gram-negative, non-motile, encapsulated bacterium known for its ability to form biofilms. Klebsiella organisms are often resistant to multiple antibiotics. It is found in the normal flora of the mouth, skin and intestines but it can cause destructive changes to the human and animal lungs, specifically to the alveoli, if aspirated. Pneumonia caused by Klebsiella bacteria, typically in the form of bronchopneumonia and bronchitis, has a death rate of around 50%, even with antimicrobial therapy. Treatment for Klebsiella pneumonia is by antibiotics, such as aminoglycosides and caphalosporins, depending on the patient's health and the severity of the disease.

Enterococcus faecalis is a gram-positive commensal bacterium inhabiting the gastrointestinal tracts of humans and other mammals. Like other species in the genus, it is found in healthy humans, but can cause life-threatening infections, such as endocarditis, sepsis and meningitis, especially in a hospital environment, where high levels of antibiotic resistance contribute to its pathogenicity. E. faecalis strains can form biofilms that are difficult to eradicate (Seno Y, et al., “Clinical implications of biofilm formation by Enterococcus faecalis in the urinary tract”. Acta Med Okayama. 2005; 59:79-87).

The medical profession has been attempting to eradicate biofilm-based infections by using disinfectants and antibiotics Docosahexaenoic acid (DHA) is a poly-unsaturated fatty acid known to exhibit anti-biofilm and anti-microbial effects. (Sun et al., (2017) ‘Antibacterial activities of docosahexaenoic acid (DHA) and eicosapentaenoic acid (EPA) against planktonic and biofilm growing Streptococcus mutans’, Microbial Pathogenesis, 107(June), pp. 212-218 and Kim, Y. G., et al., (2018) ‘Herring oil and omega fatty acids inhibit Staphylococcus aureus biofilm formation and virulence’, Frontiers in Microbiology, 9(June), p. 1241). Sun et al., (2016) reported that DHA at 200 mM, exhibited cytotoxic effects when exposed to human gingival fibroblasts (HGFs) and human periodontal ligament cells (hPDLCs) for 24 and 48 hours (Sun, M., (2016) ‘Antibacterial and antibiofilm activities of docosahexaenoic acid (DHA) and eicosapentaenoic acid (EPA) against periodontopathic bacteria’, Microbial Pathogenesis, 99(October), pp. 196-203).

KR20190140677 discloses a composition for inhibiting biofilm formation of Staphylococcus aureus. The composition comprises the omega-3 fatty acids DHA or EPA, the components of herring oil.

However, to date no effect against Klebsiella pneumoniae or Enterococcus faecalis biofilms has been reported.

Therefore, there is a need to provide an effective means to reduce or remove biofilms comprising Klebsiella pneumoniae and/or Enterococcus faecalis. This is particularly useful for application in a hospital or clinical setting.

### SUMMARY OF THE INVENTION

The current inventors have surprising found that DHA possesses strong anti-biofilm effects against Klebsiella pneumoniae and against Enterococcus faecalis, even at low micromolecular concentrations. As shown in FIG. 1, DHA was capable of reducing biofilm formation by both K. pneumoniae NCIMB 418 and E. faecalis ATCC 7080 by approximately 60%. This has not been previously reported in the art.

The inventors have also surprisingly shown that DHA significantly reduces the ability of bacteria to form pellicles on polypropylene surfaces, highlighting that DHA also can be used to prevent bacteria from colonizing and forming biofilms on surface types (FIG. 2). At high concentrations the inventors observed trends towards an ability to coat a surface and prevent biofilms forming (FIG. 3).

According to an aspect of the current invention, there is provided a method of removing, or reducing, a biofilm comprising (or consisting of) Klebsiella pneumoniae and/or Enterococcus faecalis from a non-living surface, said method comprising applying docosahexaenoic acid (DHA), or derivative thereof, to said surface.

In a preferred embodiment, the non-living surface may be selected from the surface of a surgical instrument, a medical device and/or a surface in a hospital. Still preferred, the surface may be as surface in a manufacturing setting, such as in a factory or a bioprocessing facility, or in a food manufacturing setting, such as a food manufacturing facility or factory. The surface may be the surface of a pipe or pipework.

Preferably, the concentration of DHA is from 1 μM to 200 μM, preferably from 6 μM to 100 μM.

Preferably, DHA is a composition comprising (or consisting of) DHA. The composition may be one comprising DHA with an isotopic purity of ≥90% atom % D or ≥95% or ≥98%. Typically, it is one with an isotopic purity of ≥98%.

In an embodiment, the method comprises applying a disinfectant or cleaner to the surface in combination with DHA or after the DHA has been applied.

According to a further aspect of the invention, there is provided a method for preventing, or reducing the severity of, biofilm formation on a non-living surface, said biofilm comprising Klebsiella pneumoniae and/or Enterococcus faecalis, and said method comprising applying DHA to said surface.

Preferably, DHA is a composition comprising (or consisting of) DHA.

Preferably, the concentration of DHA is from 1 μM to 1000 μM, preferably from 6 μM to 500 μM.

According to the current invention, there is provided the use of a composition comprising DHA to reduce or remove biofilms on a surface. The composition may be a disinfectant formulation. DHA may be as described herein in relation to the methods of the invention. The surface is as described herein in relation to the methods of the invention.

### Definitions and General Preferences

All publications, patents, patent applications and other references mentioned herein are hereby incorporated by reference in their entireties for all purposes as if each individual publication, patent or patent application were specifically and individually indicated to be incorporated by reference and the content thereof recited in full.

Where used herein and unless specifically indicated otherwise, the following terms are intended to have the following meanings in addition to any broader (or narrower) meanings the terms might enjoy in the art:

Unless otherwise required by context, the use herein of the singular is to be read to include the plural and vice versa. The term “a” or “an” used in relation to an entity is to be read to refer to one or more of that entity. As such, the terms “a” (or “an”), “one or more,” and “at least one” are used interchangeably herein.

As used herein, the term “comprise,” or variations thereof such as “comprises” or “comprising,” are to be read to indicate the inclusion of any recited integer (e.g. a feature, element, characteristic, property, method/process step or limitation) or group of integers (e.g. features, element, characteristics, properties, method/process steps or limitations) but not the exclusion of any other integer or group of integers. Thus, as used herein the term “comprising” is inclusive or open-ended and does not exclude additional, unrecited integers or method/process steps.

As used herein, the term “disease” is used to define any abnormal condition that impairs physiological function and is associated with specific symptoms. The term is used broadly to encompass any disorder, illness, abnormality, pathology, sickness, condition or syndrome in which physiological function is impaired irrespective of the nature of the aetiology (or indeed whether the aetiological basis for the disease is established). It therefore encompasses conditions arising from infection, trauma, injury, surgery, radiological ablation, poisoning or nutritional deficiencies.

In this context the “disease” to be treated or prevented is any type of disease caused by or associated with Klebsiella pneumoniae or Enterococcus faecalis. In particular, it is a disease caused by or associated with a biofilm formed by, or comprising, Klebsiella pneumoniae or Enterococcus faecalis.

As used herein the terms “prevention” or “preventing” refer to an intervention (e.g. the administration or application), which prevents or delays the onset of a biofilm or the severity of a biofilm.

As used herein, the term “biofilm” refers to a community of microorganisms in which cells stick to each other and which is enclosed in an extracellular polymeric substance (EPS) matrix. The cells must stick to a surface. The cells are enclosed in an extracellular polymeric substance (EPS) matrix. A biofilm may have one or more species. The biofilm may be one or more pellicles.

As used herein, the term “non-living surface” is a non-biological or abiotic material.

DHA or docosahexaenoic acid is an omega-3 fatty acid. Its structure is a carboxylic acid with 22-carbon chain and six cis double bonds, with the first double bond located at the third carbon from the omega end. DHA has the following chemical structure (Calder, (2016) Docosahexaenoic acid”, Annals of Nutrition and Metabolism, 69(1), pp. 8-21.)

A derivative of DHA or a metabolite may also be used. A derivative is a compound that is derives from DHA but differs by a structural modification, for example replacement of one atom or a group of atoms or a functional group with another atom or group of atoms or functional group. It is a “functional derivative” in that is has the same function, e.g. can treat or prevent a biofilm in a subject. Examples are in Yonggang Ma, et al., “DHA derivatives of fish oil as dietary supplements; a nutrition-based drug discovery approach for therapies to prevent metabolic cardiotoxicity”, Expert Opin Drug Discov. 2012, August 7(8): 711-721.

### BRIEF DESCRIPTION OF THE FIGURES

The invention will be more clearly understood from the following description of an embodiment thereof, given by way of example only, with reference to the following Figures in which;

FIG. 1: The effect of varying concentrations of DHA on the ability of Klebsiella pneumoniae NCIMB 418 (A) and Enterococcus faecalis ATCC 7080 (B) to form a biofilm in vitro. (10⁶ CFU/well was incubated with various concentrations of DHA in a 96 well plate for 24 hours statically at 37° C. Biofilm formation was assessed using the crystal violet assay. Data represents the mean±SD for six independent experiments, carried out in triplicate. One-way ANOVA was performed for statistical analysis. *****P<0.001 compared to both the control (no DHA) and vehicle control (1% DMSO).

FIG. 2: The effect of varying concentrations on the ability of Klebsiella pneumoniae NCIMB 418 pellicle formation on polypropylene surfaces in vitro. 10⁶ CFU/well was incubated with various concentrations of DHA statically for 7 days at 37° C. Biofilm formation was assessed using the crystal violet assay. Data represents the mean±SD for three independent experiments, carried out in duplicate. One-way ANOVA was performed for statistical analysis. *P<0.05 compared to both the control (CTRL, no DHA) and vehicle control (1% DMSO).

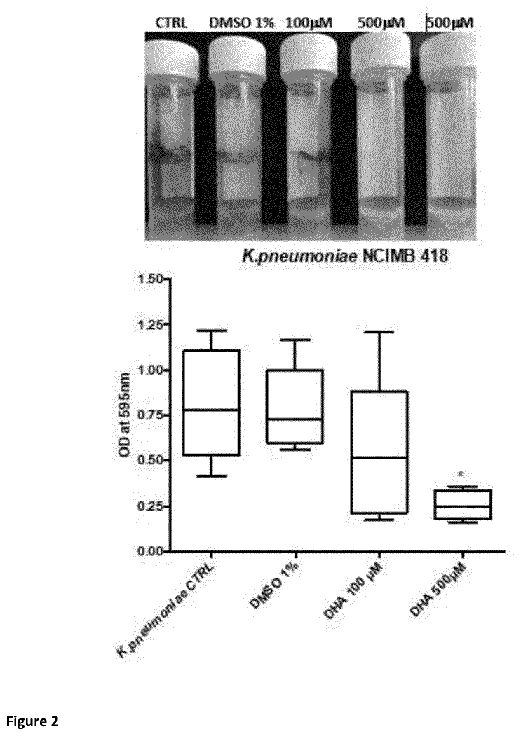

FIG. 3: Evaluating DHA on the ability of Klebsiella pneumoniae NCIMB 418 to form a biofilm on glass coverslips in vitro. 10⁶ CFU/well was incubated with DHA in a 6 well plate for 24 hours statically at 37° C. Biofilm formation was assessed using the crystal violet assay. Data represents the mean±SD for one independent experiment, carried out in duplicate One-way ANOVA was performed for statistical analysis. No significant reduction in biofilm formation was achieved in comparison to untreated control.

### DETAILED DESCRIPTION OF THE INVENTION

Biofilms are notoriously difficult to remove or disrupt. The current inventors have surprising found that DHA possesses strong anti-biofilm effects against Klebsiella pneumoniae and against Enterococcus faecalis. This provides an effective means to remove or reduce biofilms on a non-living surface. This is particularly beneficial for preventing spread of infection caused by Klebsiella pneumoniae or Enterococcus faecalis in a hospital setting.

The surface is a non-living surface.

The surface may be selected from the group comprising a surgical instrument, a medical device, a surface in a hospital. The surface may be one in a manufacturing setting, such as a bioprocessing facility or a factory. The surface may be one in a food manufacturing setting, such as a food manufacturing facility or factory. The surface may be a non-medical device, such as the surface of a bedframe, an infusion pump stand, a keyboard, a counter surface, piping, a floor, a wall or any type of work surface. The surface may be any laminated surface. The surface may be an uneven surface, such as one with grooves or bumps, such as work surfaces or tiled floors.

Notably, the DHA or composition may be pumped or flushed through piping in order to reduce or remove biofilms in the piping.

The surface may be that of a surgical instrument or medical device. It may be the outer or inner surface of the surgical instrument or medical device.

The surgical instrument may be but is not limited to an endoscope or other intricate fibre optic surgical instrument. The surgical instrument may be a forceps, scissors, scalpel, or electrodes.

The medical device may be one that is to be implanted in a patient. For example, in such an embodiment, the medical device may be treated with DHA prior to being implanted in a patient/subject to ensure removal of any biofilm comprising Klebsiella pneumoniae and/or Enterococcus faecalis, so as to prevent infecting the subject. Generally, the medical device would also be sterilized or irradiated. This may be before or after DHA treatment.

The surface may be a polypropylene surface or a glass surface.

Application may be by any suitable means, such as spraying, dripping, wiping or painting. Application may be a single application, or it may be multiple applications. One example is using a nano spray device.

Removal may be complete removal or partial removal, i.e. reduction. Removal may be 100%, at least 90%, at least 80%, at least 70%, at least 60%, or at least 50%, or at least 40%, at least 30%, or at least 20%. Removal may be from 50% to 60%, or 60% to 70% or 80% and 90% or 90% and 95%. Typically, about 60% or 65% of the biofilm formed on the surface is removed.

In an embodiment, DHA may be used in combination with a disinfectant or cleaner. For example, the method may comprise application of DHA to the surface first and then followed by application of the disinfectant or cleaner, immediately or after a short period of time. Application may be simultaneous. The disinfectant or cleaner may be any known or used disinfectant or cleaner. Examples include isopropyl alcohol disinfectant (IPA) and Virkon™.

Virkon™ contains oxone, sodium dodecylbenzenesulfonate, sulfamic acid and inorganic buffers. Not to be bound by theory, it is considered that if the biofilm is not completely removed by DHA treatment, that the DHA treatment would weaken the biofilm remaining to such an extent that it could be removed with a standard disinfectant or cleaner.

The amount of DHA may be an effective amount to achieve the desired effect, i.e. to reduce or remove the biofilm. The concentration of DHA used in the method may be from 1 μM to 500 μM, preferably 1 μM to 300 μM or 200 μM, preferably from 5 μM to 150 μM, from 6 μM to 100 μM, or from 10 μM to 90 μM, from 20 μM to 80 μM, from 30 μM to 70 μM, from 40 μM to 60 μM or 50 μM. Notably, the amount of DHA may be 6.25 μM to 100 μM, or 12.5 μM to 50 or 25 μM.

In an embodiment, DHA is in liquid form. However, it will be appreciated that any suitable formulation of DHA may be used.

Application may be a single application, or it may be multiple applications. It may be for any suitable period of time.

DHA significantly reduces the ability of bacteria to form pellicles on polypropylene surfaces. Therefore, notably, the invention also provides a method of preventing Klebsiella pneumoniae or Enterococcus faecalis biofilm formation on a surface, the method comprising applying an amount of DHA to a surface. Such a method prevents biofilms from forming and thus significantly reduces the risk of infection of a subject when encountering the surface. This is particularly beneficial in a clinical or hospital setting, especially circumstance in which the surface is the interior or exterior surface of a surgical instrument or medical device. For example, a medical device may be treated or coated with DHA prior to being implanted in a subject.

The surface in any method of the invention is a non-living surface.

The surface may be selected from the group comprising a surgical instrument, a medical device, a surface in a hospital. The surface may be one in a manufacturing setting, such as a bioprocessing facility or a factory. The surface may be one in a food manufacturing setting, such as a food manufacturing facility or factory The surface may be a non-medical device, such as the surface of a bedframe, an infusion pump stand, a keyboard, a counter surface, piping, a floor, a wall or any type of work surface. The surface may be any laminated surface. The surface may be an uneven surface, such as one with grooves or bumps, such as work surfaces or tiled floors.

The surface may be that of a surgical instrument or medical device. It may be the outer or inner surface of the surgical instrument or medical device. The surgical instrument may be a forceps, scissors, scalpel or electrodes.

The surgical instrument may be but is not limited to an endoscope or other intricate fibre optic surgical instrument.

The medical device may be one that is to be implanted in a patient. The medical device may be one that is to be implanted in a patient. For example, in such an embodiment, the medical device may be treated, e.g. coated, with DHA prior to being implanted in a patient/subject to ensure prevention of formation of biofilm comprising Klebsiella pneumoniae and/or Enterococcus faecalis, so as to prevent infecting the subject. The medical device may also be sterilised or irradiated.

Application in this method of the invention may also serve to remove any biofilm already present on the surface as well as preventing further formation.

Application may be a single application, or it may be multiple applications.

Application may be by any suitable means, such as spraying, dripping, wiping or painting. Preferably, the application is such that a coating or layer of DHA is applied to the surface. For example, application may be using a nano spray device which can apply a fine layer of liquid to the surface for coating

The coating may be any thickness. Notably, the coating is a thin layer and evenly coats the surface.

Preferably, the coating is allowed to dry. The coating may be allowed to dry at any suitable temperature for any suitable amount of time. Typically, the coating is dried at room temperature and preferably in a sterile environment, for example in a laminar air flow unit.

Prevention may be complete, i.e. 100% prevention, or partial prevention, i.e. reducing the severity of the biofilm formation compared with the surface if it was untreated. The severity may be reduced by at least 50%, at least 60%, at least 70%, at least 80%, at least 90%.

The amount of DHA may be an effective amount to prevent biofilm formation. The concentration of DHA used in the method may be from 1 μM to 1000 μM, preferably from 2 μM to 900 μM, from 3 μM to 800 μM, or from 10 μM to 700 μM, from 20 μM to 600 μM, from 30 μM to 500 μM, from 40 μM to 400 μM, from 50 μM to 300 μM, from 60 μM to 200 μM, from 70 μM to 100 μM. Typically, the concentration of DHA is 100 μM to 500 μM, or 200 μM to 400 μM.

In an embodiment, DHA is in liquid form. However, it will be appreciated that any suitable formulation of DHA may be used. This applies to all embodiments and aspects of the invention. It may be a disinfectant formulation. It may contain any water or excipients normally found in disinfectant formulations.

The medical device described herein in relation to the method(s) of the invention may be selected from the group comprising but not limited to prosthetic heart valves, orthopaedic implants, intravascular catheters, artificial hearts, left ventricular assist devices, cardiac pacemakers, defibrillator, vascular prostheses, cerebrospinal fluid shunts, urinary catheters, ocular prostheses and contact lenses, and intrauterine contraceptive device. The medical device may be an indwelling medical device. The device may be one that has not yet been implanted in a patient or subject.

The clinical settling may be a hospital, or clinic, a doctor or consultant surgery. It may also include extended care facilities, ambulatory surgical units home healthcare sites and other healthcare settings.

The biofilm in any aspect of the invention may comprise (or consist) of Klebsiella pneumoniae.

The biofilm in any aspect of the invention may comprise (or consist) of Enterococcus faecalis.

It will be appreciated that the embodiments described in relation to one aspect of the invention may also apply to other aspects of the invention.

### EXEMPLIFICATION

The invention will now be described with reference to specific Examples. These are merely exemplary and for illustrative purposes only: they are not intended to be limiting in any way to the scope of the monopoly claimed or to the invention described. These examples constitute the best mode currently contemplated for practicing the invention.

### Example 1

Evaluating DHA for Anti-Biofilm Effects Against Klebsiella pneumoniae NCIMB 418 and Enterococcus faecalis ATCC 7080

### Methodology

The effect of varying concentrations of DHA on the ability of Klebsiella pneumoniae NCIMB 418 and Enterococcus faecalis ATCC 7080 to form a biofilm in vitro was investigated. 10⁶ CFU/well was incubated with various concentrations of DHA in a 96 well plate for 24 hours statically at 37° C. Biofilm formation was assessed using the crystal violet assay. Data represents the mean±SD for six independent experiments, carried out in triplicate. The assay involved seeding cells at 10⁶ CFU/ml in media with DHA. Cells were then left for 24 hrs to form biofilms before washing and staining with Crystal Violet. Crystal violet adhered to cells stuck to the sides of the tube/well. The samples were washed again to remove any unbound dye before dissolving the stain in acetic acid and the reading was measured in a spectrophotometer. The colour intensity relates to the level of biofilm present. The more colour the more bacteria in the biofilm (Merrit, J. H, et al., (2005) “Growing and Analysing Static Biofilms”, Current Protocols in Microbiology, Chapter 1(July), p. Unit 1B.1.).

### Results and Conclusion

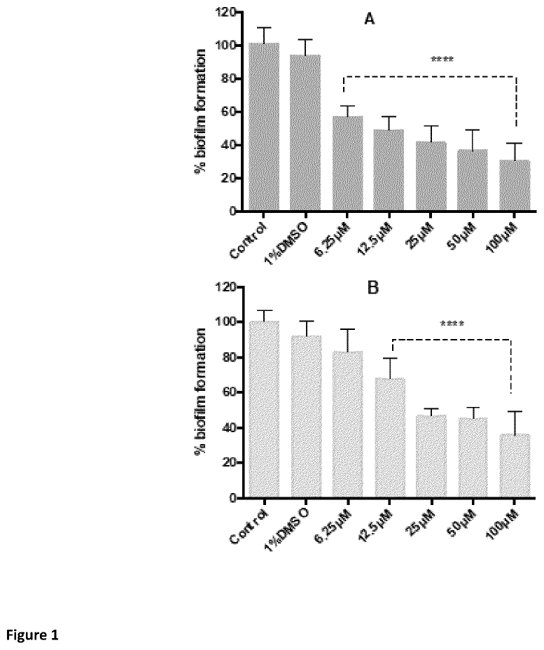

As show in FIG. 1 A, an anti-biofilm effect was seen against of Klebsiella pneumoniae NCIMB 418 with DHA versus control at concentrations between 6.25 μM (˜40% reduction) and 100 μM (˜65% reduction).

As show in FIG. 1 B an anti-biofilm effect was seen against Enterococcus faecalis ATCC 7080 with DHA versus control at concentrations between 6.25 μM (˜20% reduction) and 100 μM (˜65% reduction).

### Example 2

Evaluating DHA for Antibiofilm Effects Against Pellicle Formation in Klebsiella pneumoniae NCIMB 418 Pellicle on Polypropylene (PP) Surfaces

### Methodology

The effect of varying concentrations on the ability of Klebsiella pneumoniae NCIMB 418 pellicle formation on polypropylene surfaces in vitro was investigated. 10⁶ CFU/well was incubated with various concentrations of DHA statically for 7 days at 37° C. Biofilm formation was assessed using the crystal violet assay. Data represents the mean±SD for three independent experiments, carried out in duplicate.

### Results and Conclusion

DHA significantly reduces the ability of bacteria to form pellicles on polypropylene surfaces DHA can be used as a surface coating to prevent the formation of bacterial biofilms.

### Example 3

### Evaluating DHA for the Ability to Prevent Biofilm Formation by Klebsiella Pneumoniae NCIMB 418 on Glass Surfaces

### Methodology

The effect of DHA on the ability of Klebsiella pneumoniae NCIMB 418 to form a biofilm on glass coverslips in vitro was investigated. 10⁶ CFU/well was incubated with DHA in a 6 well plate for 24 hours statically at 37° C. Biofilm formation was assessed using the crystal violet assay. Data represents the mean±SD for one independent experiment, carried out in duplicate One-way ANOVA was performed for statistical analysis.

### Results and Conclusion

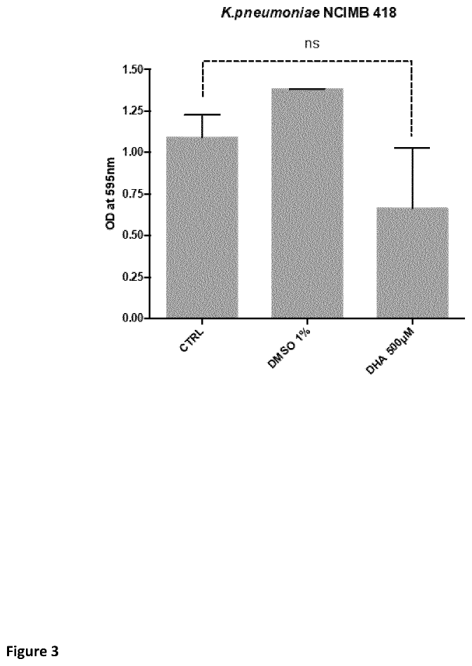

As shown in FIG. 3, a reduction in severity or extent of the biofilm formed was seen with DHA treatment.

### EQUIVALENTS

The foregoing description details presently preferred embodiments of the present invention. Numerous modifications and variations in practice thereof are expected to occur to those skilled in the art upon consideration of these descriptions. Those modifications and variations are intended to be encompassed within the claims appended hereto.

1. A method for preventing biofilm formation on a non-living surface, said biofilm comprising Klebsiella pneumoniae and/or Enterococcus faecalis, and said method comprising applying DHA, or a derivative thereof, to said surface.

2. The method of claim 1, wherein the surface is the surface of a surgical instrument, a medical device, a surface in a clinical setting, a surface in a bioprocessing facility, or the surface in a food processing facility.

3. The method of claim 2, wherein said medical device is to be implanted into a subject.

4. The method of any one of the preceding claims, wherein the surface is an interior and/or exterior surface.

5. The method of any one of claims 1 to 4, wherein the surface comprises polypropylene or glass.

6. The method of any one of claims 1 to 5, wherein DHA is applied by spraying, dripping, wiping, or painting.

7. The method of any one of claims 1 to 6, wherein DHA is applied as a coating or layer on the surface.

8. The method of claim 7 wherein said coating is dried.

9. The method of any one of claims 1 to 8, wherein DHA is applied at a concentration of 100 μM to 1000 μM.

10. The method of claim 9, wherein the DHA is applied at a concentration of from 6 μM to 500 μM.

11. The method of any one of claims 1 to 10, wherein the biofilm comprises Klebsiella pneumoniae.

12. The method of claim 11, wherein the biofilm consists of Klebsiella pneumoniae.

13. A method for removing, or reducing, a biofilm comprising Klebsiella pneumoniae and/or Enterococcus faecalis from a non-living surface, said method comprising applying DHA, or a derivative thereof, to said surface.

14. The method of claim 13, wherein the surface is the surface of a surgical instrument, a medical device, a surface in a clinical setting, a surface in a bioprocessing facility or the surface in a food manufacturing facility.

15. The method of claim 13 or 14, wherein the surface is an interior and/or exterior surface.

16. The method of any one of claims 13 to 15 wherein the surface comprises polypropylene or glass.

17. The method of any one of claims 13 to 17, in which the biofilm comprises Klebsiella pneumoniae and Enterococcus faecalis.

18. The method of claim 17, wherein the biofilm consists of Klebsiella pneumoniae and Enterococcus faecalis.

19. The method of any one of claims 13 to 18, wherein DHA is applied by spraying, dripping, wiping, or painting.

20. The method of any one of claims 13 to 19, wherein removal is at least 70%.

21. The method of any one of claims 13 to 20, wherein the method comprises application of a disinfectant or cleaner after application of DHA to the surface.

22. The method of any one of claims 13 to 21, wherein DHA is applied at a concentration of from 1 μM to 200 μM.

23. The method of any one of claims 1 to 12, or the method of any one of claims 13 to 22, wherein the biofilm comprises one or more pellicles.
